(19) United States
(12) Patent Application Publication
(10) Pub. No.: US 2011/0083440 A1
(43) Pub. Date: Apr. 14, 2011

(54) HIGH STRENGTH CROSSOVER MANIFOLD AND METHOD OF JOINING

(75) Inventor: Lucas John Stoia, Taylors, SC (US)

(73) Assignee: GENERAL ELECTRIC COMPANY, Schenectady, NY (US)

(21) Appl. No.: 12/578,894

(22) Filed: Oct. 14, 2009

(51) Int. Cl. F02C 7/22; B23P 17/00

(52) U.S. Cl. 60/740; 29/888; 219/57

(57) ABSTRACT

A secondary fuel nozzle includes a plurality of tubes axially extending downstream within the secondary fuel nozzle, the tubes defining passages operable to allow a flow of fluid to flow through each of the passages, the passages including an outermost tertiary passage and a radially inner secondary fuel passage. The secondary fuel nozzle also includes a fuel peg extending radially outward from the axially extending tubes, the fuel peg operable to emit a fluid radially outward therefrom. The secondary fuel nozzle further includes a crossover manifold attached to the fuel peg and in fluid communication with the radially inner secondary fuel passage and the fuel peg, wherein the crossover manifold is attached to the corresponding tubes that define the tertiary passage and the radially inner secondary passage by butt welds.

### BACKGROUND OF THE INVENTION

The subject matter disclosed herein relates to a secondary fuel nozzle for a gas turbine and, in particular, to a high strength crossover manifold and method of joining for use in gas turbine fuel nozzles.

A gas turbine combustor is a device used for mixing fuel and air, and burning the resulting mixture. Gas turbine compressors pressurize inlet air, which is then typically turned in direction or reverse flowed to the combustor where it is used to cool the combustor and also to provide air to the combustion process. Multiple combustion chamber assemblies may be utilized to achieve reliable and efficient turbine operation. Each combustion chamber assembly typically comprises a cylindrical combustor liner, a fuel injection system, and a transition piece that guides the flow of the hot gas from the combustor liner to the inlet of the turbine section. Gas turbines may include one combustor or several combustors arranged in a circular array about the turbine rotor axis.

The gas turbine typically includes a plurality of primary fuel nozzles that provide fuel to an upstream combustion zone. The primary fuel nozzles are typically arranged in an annular array around a central secondary fuel nozzle. Ignition may be achieved in the various combustors by use of a sparkplug in conjunction with crossfire tubes. The secondary fuel nozzle typically provides fuel delivery to a downstream combustion zone.

The secondary fuel nozzle typically has three fuel introduction locations, including a plurality of secondary nozzle pegs, a secondary nozzle pilot tip, and a tertiary tip. The secondary nozzle pilot tip and the tertiary tip are typically co-located at the axial downstream end of the secondary fuel nozzle, while the plurality of secondary nozzle pegs are located a portion of the distance towards the axial downstream end of the secondary fuel nozzle. Each secondary nozzle peg provides fuel to a pre-mix reaction zone of the combustor, while the secondary nozzle pilot tip/tertiary tip provides fuel to the downstream combustion chamber where it is burned (diffusion combustion). The secondary nozzle is a combustion system fuel delivery device that may have separate and individually controlled fuel circuits that allow for the ability to individually vary fuel flow rates delivered to the three fuel introduction locations. For example, the fuel flow rate through the secondary nozzle pilot tip/tertiary tip may be varied independently from the fuel flow rate through the secondary nozzle pegs and vice versa. Further, the secondary nozzle pegs, the secondary nozzle pilot tip and the tertiary tip each typically has its own independent fuel piping circuit, with each circuit having an independent and exclusive fuel source.

At the location of the secondary nozzle pegs, the secondary fuel nozzle typically includes a crossover manifold. The manifold allows fuel to be conveyed radially outward to the pegs and across the outermost, tertiary fuel circuit that axially feeds the tertiary tip. Thus, the crossover manifold feeds fuel to the pegs across the outer tertiary or “transfer” passage. A sub-pilot fuel passage is located radially inbound of the secondary fuel passage that feeds the pegs. As such, the crossover manifold typically does not “cross over” the sub-pilot passage.

There commonly exists a plurality of fuel circuits or passages that are spaced about the centerline of the secondary fuel nozzle. These fuel circuits or passages are generally defined or bounded by concentric tubes made from, e.g., stainless steel. The crossover manifold creates an array of annular shaped slots that allow the outer tertiary circuit to pass fuel or air from upstream to downstream of the location of the crossover manifold at the secondary nozzle pegs.

It is known to attach the crossover manifold to the appropriate fuel circuit tubes (and, thus, to the appropriate fuel circuit) through use of welding or other joining process of the peg tube portions to the fuel circuit tubes (for example, by electron beam welding, tungsten inert gas (TIG) welding, or brazing). Specifically, it is known to use an intermittent socket/butt weld to join or attach the several outermost tubes to the crossover manifold. A butt weld is typically a weld where two pieces or components (e.g., an end surface of a fuel circuit tube and an end surface of a corresponding mating portion of the crossover manifold) are joined together so as to produce a full penetration weld. A socket weld is typically a weld where one piece or component is slipped over another piece or component and then joined together (e.g., another portion of the peg tube portion and the corresponding fuel circuit tube). A socket weld is commonly considered a partial penetration weld that is typically of lower strength than a butt weld.

The known crossover manifold intermittent combination socket and butt weld may pose durability or product life issues. This is due to the fact that the typical operating thermals in this region of the secondary fuel nozzle where the crossover manifold joins the fuel circuit tubes may cause the welds to be relatively highly stressed on the inner side of the welds, which may possibly lead to low cycle fatigue cracking. This is due primarily to the relatively greatest or peak strains or stresses at the relatively sharp corners that are inherent in this type of partial penetration or interrupted combination socket and butt weld. The fluids (air and fuel) in this location of the secondary fuel nozzle are of different temperatures and, as a result, may cause thermal gradients and subsequent thermal strains or stresses in this location.

### BRIEF DESCRIPTION OF THE INVENTION

According to one aspect of the invention, a secondary fuel nozzle includes a plurality of tubes axially extending downstream within the secondary fuel nozzle, the tubes defining passages operable to allow a flow of fluid to flow through each of the passages, the passages including an outermost tertiary passage and a radially inner secondary fuel passage. The secondary fuel nozzle also includes a fuel peg extending radially outward from the axially extending tubes, the fuel peg operable to emit a fluid radially outward therefrom. The secondary fuel nozzle further includes a crossover manifold attached to the fuel peg and in fluid communication with the radially inner secondary fuel passage and the fuel peg, wherein the crossover manifold is attached to the corresponding tubes that define the tertiary passage and the radially inner secondary passage by butt welds.

According to another aspect of the invention, a secondary fuel nozzle includes a plurality of tubes defining passages, each of the passages operable to allow a flow of fluid to flow therethrough, the passages including an outer tertiary passage and an inner secondary fuel passage. The secondary fuel nozzle also includes a fuel peg extending radially outward from the tubes, the fuel peg operable to emit a fluid outward therefrom. The secondary fuel nozzle further includes a crossover manifold attached to the fuel peg and in fluid communication with the inner secondary fuel passage and the fuel peg, wherein the crossover manifold is attached to the corresponding tubes that define the tertiary passage and the inner secondary passage by butt welds.

According to yet another aspect of the invention, a method includes the step of providing a plurality of tubes axially extending downstream within a secondary fuel nozzle, the tubes defining passages operable to allow a flow of fluid to flow through each of the passages, the passages including an outermost tertiary passage and a radially inner secondary fuel passage. The method also includes the step of providing a fuel peg extending radially outward from the axially extending tubes, the fuel peg operable to emit a fluid radially outward therefrom. The method further includes the steps of attaching a crossover manifold to the fuel peg and in fluid communication with the radially inner secondary fuel passage and the fuel peg, and butt welding the crossover manifold to the corresponding tubes that define the tertiary passage and the radially inner secondary passage.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a partial cross section of a gas turbine for use in accordance with embodiments of the invention;

FIG. 2 is a cross section of an exemplary secondary fuel nozzle for use in accordance with embodiments of the invention;

FIG. 3 is a detailed cross section of a portion of a secondary nozzle peg area of the secondary fuel nozzle of FIG. 2;

FIG. 4 is a cross section through the secondary nozzle peg area of the secondary fuel nozzle of FIG. 2; and

FIG. 5 is a cross section through the secondary fuel nozzle of FIG. 2 upstream of the secondary nozzle peg area looking downstream towards the secondary nozzle peg area.

The detailed description explains embodiments of the invention, together with advantages and features, by way of example with reference to the drawings.

### DETAILED DESCRIPTION OF THE INVENTION

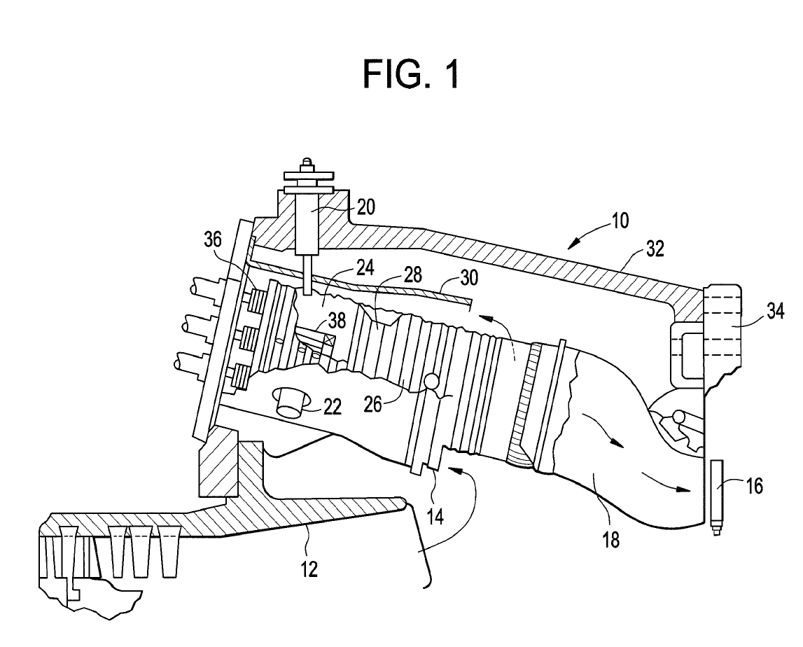

In FIG. 1 is a gas turbine 10 (partially shown), which includes a compressor 12 (also partially shown), a plurality of combustors 14 (one shown), and a turbine section represented by a single blade 16. Although not specifically shown, the turbine is drivingly connected to the compressor 12 along a common axis. The compressor 12 pressurizes inlet air, which is then reverse flowed to the combustor 14 where it is used to cool the combustor and to provide air to the combustion process. The plurality of combustors 14 may be located in an annular array about the axis of the gas turbine 10. A transition duct 18 connects the outlet end of each combustor 14 with the inlet end of the turbine to deliver the hot products of combustion to the turbine in the form of an approved temperature profile.

Each combustor 14 may comprise a primary or upstream combustion chamber 24 and a secondary or downstream combustion chamber 26 separated by a venturi throat region 28. The combustor 14 is surrounded by a combustor flow sleeve 30, which channels compressor discharge air flow to the combustor 14. The combustor 14 is further surrounded by an outer casing 32, which is bolted to a turbine casing 34. A plurality of primary fuel nozzles 36 provide fuel delivery to the upstream combustor 24 and are arranged in an annular array around a central secondary fuel nozzle 38. Ignition is achieved in the various combustors 14 by use of, e.g., a sparkplug 20 in conjunction with crossfire tubes 22 (one shown). The secondary fuel nozzle 38 provides fuel delivery to the downstream combustion chamber 26.

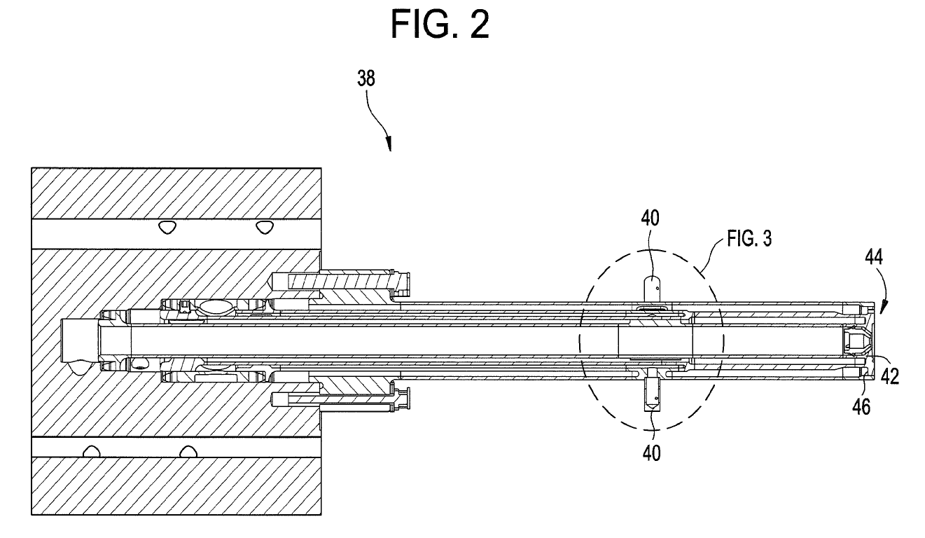

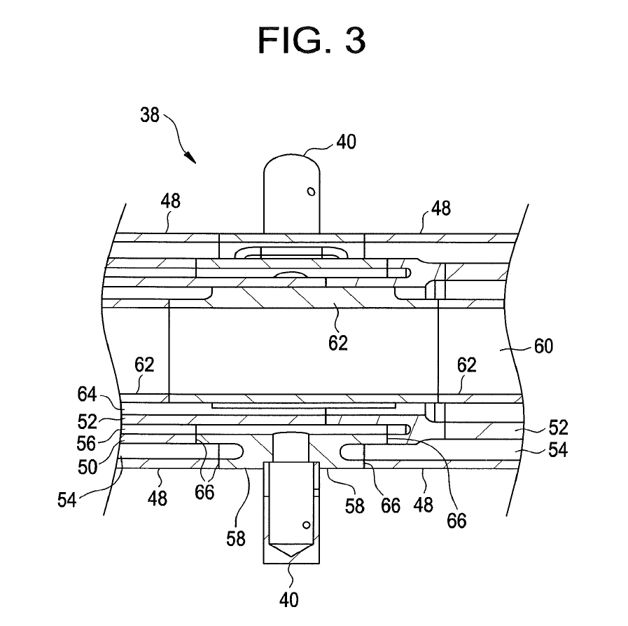

In FIG. 2 is the secondary fuel nozzle 38 of FIG. 1 in which embodiments of the present invention may be located. The secondary fuel nozzle 38 may have three fuel introduction locations, including a plurality of secondary nozzle pegs 40, a secondary nozzle pilot tip 42 located at an axial downstream end 44 of the secondary fuel nozzle 38, and a tertiary tip 46 co-located with the secondary nozzle pilot tip 42 at the axial downstream end 44 of the secondary fuel nozzle 38. The plurality of secondary nozzle pegs 40 are located a portion of the distance towards the downstream end 44 of the secondary fuel nozzle 38. Each secondary nozzle peg 40 provides fuel to a pre-mix reaction zone of the combustor 14, while the secondary nozzle pilot tip 42/tertiary tip 46 provides fuel to the downstream combustion chamber 26 where it is burned (diffusion combustion). The secondary nozzle 38 is a combustion system fuel delivery device that typically has separate and individually controlled fuel circuits (FIG. 3), which allow for the ability to individually vary fuel flow rates delivered to the three fuel introduction locations. For example, the fuel flow rate through the secondary nozzle pilot tip 42/tertiary tip 46 may be varied independently from the fuel flow rate through the secondary nozzle pegs 40 and vice versa. Further, the secondary nozzle pegs 40, the secondary nozzle pilot tip 42, and the tertiary tip 46 each has its own independent fuel piping circuit, with each circuit having an independent and exclusive fuel source, as described in more detail with respect to FIG. 3.

In FIG. 3 are the secondary nozzle pegs 40 and the several independent fuel circuits and passages shown in more detail. Specifically, the cross section of FIG. 3 is taken both through the secondary fuel nozzle 38 between pegs 40 at the upper peg 40 shown in FIG. 3 and through the secondary fuel nozzle 38 through the center of the lower peg 40 shown in FIG. 3. The secondary fuel nozzle 38 may comprise a series of concentric tubes. The two radially outermost concentric tubes 48 and 50 on the upstream side of the pegs 40 and tubes 48 and 52 on the downstream side of the pegs 40 define or form the boundaries of a tertiary gas passage 54. The tertiary gas passage 54 provides tertiary gas downstream in the secondary fuel nozzle 38 to the tertiary tip 46 (FIG. 2).

A secondary gas fuel passage 56, adjacent the tertiary gas passage 54, is formed between concentric tubes 50 and 52 on the upstream side of the pegs 40 and is bounded (i.e., stopped from any further flow downstream in the secondary fuel nozzle 38) on a downstream side of the pegs 40 by the tube 52. The secondary gas fuel passage 56 communicates with the radially extending secondary nozzle peg 40 arranged about the circumference of the secondary fuel nozzle 38 and supplies secondary gas fuel to the secondary nozzle peg 40 through a crossover manifold 58. The crossover manifold 58, which may comprise stainless steel in a similar manner to the various tubes 48, 50, 52, is connected with or attached to the corresponding tubes as described in more detail hereinafter with respect to embodiments of the invention. As seen in FIG. 3, through use of the crossover manifold 58, the secondary gas fuel “crosses over” the outermost tertiary gas passage 54 at the location of the peg 40 and radially flows through the peg 40.

A liquid fuel passage 60, the innermost of the series of concentric passages forming the secondary nozzle 38, is defined by tube 62. The liquid fuel passage 60 provides liquid fuel to the secondary nozzle pilot tip 42. One or more other fuel, gas and/or water passages in the secondary fuel nozzle 38 may be defined by the appropriate fuel circuits and tubes. For example, a sub-pilot fuel passage 64 may be defined by the tubes 52, 62. The sub-pilot fuel passage 64 may provide fuel downstream in the secondary fuel nozzle 38 to the secondary nozzle pilot tip 42. The number of fuel circuits may be varied according to operational and design considerations for the secondary fuel nozzle 38.

Each peg 40 may be attached by, e.g., welding to the crossover manifold 58. In accordance with embodiments of the present invention, end axial end surfaces of the crossover manifold 58 may be attached by butt welds 66 to corresponding end axial surfaces of each of the corresponding tubes 48, 50, 52. The butt welds 66 may be achieved, for example, by electron beam welding, tungsten inert gas (TIG) welding, brazing or other types of attachment methods. As described hereinabove, a butt weld is typically a weld where two pieces or components are joined together end surface to end surface. In contrast, a socket weld is typically a weld where one piece or component is slipped over another piece or component and then joined together not in an end-to-end manner as in a butt weld. Embodiments of the invention eliminate the need to use any type of socket weld to connect the crossover manifold 58 to the corresponding tubes 48, 50, 52. This is because the tubes 48, 50, 52 require no overlap connections. In addition, this type of butt weld 66 is generally referred to as a “fully penetrated” butt weld, which results in a crossover manifold 58 of relatively higher strength.

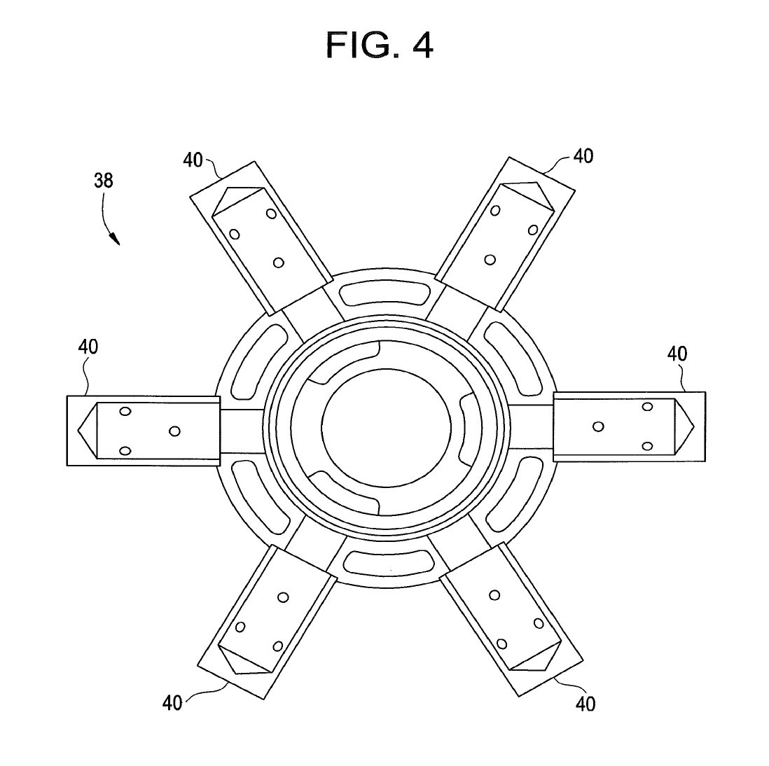

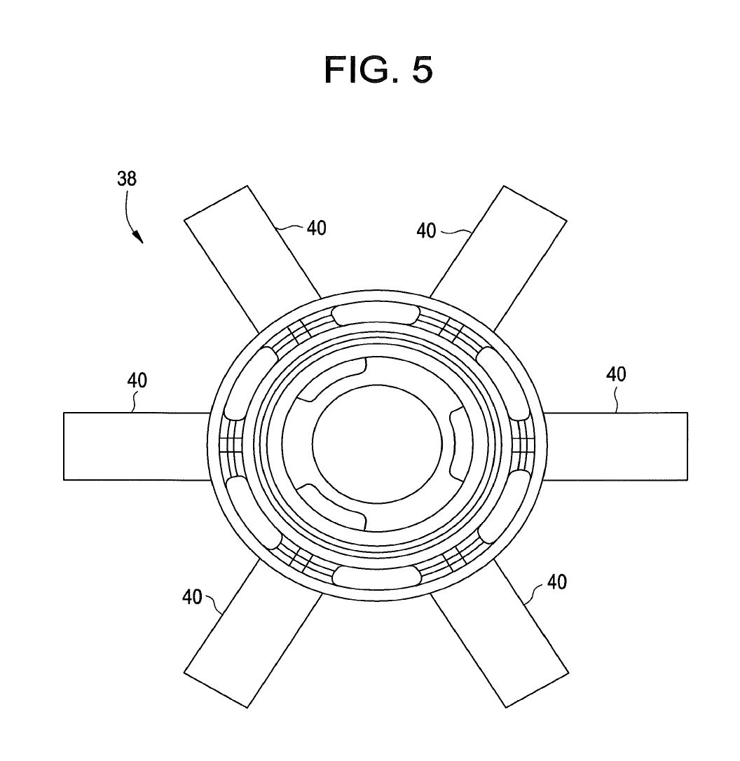

FIGS. 4 and 5 illustrate the location on the secondary fuel nozzle 38 of the pegs 40 in more detail. FIG. 4 is a cross section through the secondary nozzle peg area of the secondary fuel nozzle 38 of FIG. 2, while FIG. 5 is a cross section through the secondary fuel nozzle 38 of FIG. 2 upstream of the secondary nozzle peg area looking downstream towards the secondary nozzle peg area.

Embodiments of the invention provide for “fully penetrated” butt welds, which when used to connect a crossover manifold 58 to the corresponding fuel circuit tubes 48, 50, 52, result in a reduced amount of stress or strain placed on the components that are welded and the weld itself. Compared to the prior art, the butt weld is more flexible than the socket weld. This drives the thermally induced loads to be reacted in a smooth radius of the parent material, which has more low cycle fatigue capability as compared to the weld joint. This is because the weld joint typically has properties similar to that of the cast material.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A secondary fuel nozzle, comprising:
a plurality of tubes axially extending downstream within the secondary fuel nozzle, the tubes defining passages operable to allow a flow of fluid to flow through each of the passages, the passages including an outermost tertiary passage and a radially inner secondary fuel passage;
a fuel peg extending radially outward from the axially extending tubes, the fuel peg operable to emit a fluid radially outward therefrom; and
a crossover manifold attached to the fuel peg and in fluid communication with the radially inner secondary fuel passage and the fuel peg;
wherein the crossover manifold is attached to the corresponding tubes that define the tertiary passage and the radially inner secondary passage by butt welds.

2. The secondary fuel nozzle of claim 1, wherein the butt welds comprise tungsten inert gas welds.

3. The secondary fuel nozzle of claim 1, wherein the butt welds comprise electron beam welds.

4. The secondary fuel nozzle of claim 1, wherein the butt welds comprise brazes.

5. The secondary fuel nozzle of claim 1, wherein surfaces of the crossover manifold are attached to surfaces of the corresponding tubes that define the tertiary passage and the radially inner secondary passage by butt welds.

6. The secondary fuel nozzle of claim 1, further comprising:
a plurality of fuel pegs extending radially outward from the axially extending tubes, each fuel peg operable to emit a fluid radially outward therefrom; and
a plurality of crossover manifolds, each crossover manifold attached to the corresponding one of the fuel pegs and in fluid communication with the inner secondary fuel passage and the corresponding one of the fuel pegs;
wherein each one of the crossover manifolds is attached to the corresponding tubes that define the tertiary passage and the radially inner secondary passage by butt welds.

7. A secondary fuel nozzle, comprising:
a plurality of tubes defining passages, each of the passages operable to allow a flow of fluid to flow therethrough, the passages including an outer tertiary passage and an inner secondary fuel passage;
a fuel peg extending radially outward from the tubes, the fuel peg operable to emit a fluid outward therefrom; and
a crossover manifold attached to the fuel peg and in fluid communication with the inner secondary fuel passage and the fuel peg;
wherein the crossover manifold is attached to the corresponding tubes that define the tertiary passage and the inner secondary passage by butt welds.

8. The secondary fuel nozzle of claim 7, wherein the butt welds comprise tungsten inert gas welds.

9. The secondary fuel nozzle of claim 7, wherein the butt welds comprise electron beam welds.

10. The secondary fuel nozzle of claim 7, wherein the butt welds comprise brazes.

11. The secondary fuel nozzle of claim 7, wherein surfaces of the crossover manifold are attached to surfaces of the corresponding tubes that define the tertiary passage and the inner secondary passage by butt welds.

12. The secondary fuel nozzle of claim 7, further comprising:
a plurality of fuel pegs extending radially outward from the tubes, each fuel peg operable to emit a fluid outward therefrom; and
a plurality of crossover manifolds, each crossover manifold attached to the corresponding one of the fuel pegs and in fluid communication with the inner secondary fuel passage and the corresponding one of the fuel pegs;
wherein each one of the crossover manifolds is attached to the corresponding tubes that define the tertiary passage and the radially inner secondary passage by butt welds.

13. A method, comprising:
providing a plurality of tubes axially extending downstream within a secondary fuel nozzle, the tubes defining passages operable to allow a flow of fluid to flow through each of the passages, the passages including an outermost tertiary passage and a radially inner secondary fuel passage;
providing a fuel peg extending radially outward from the axially extending tubes, the fuel peg operable to emit a fluid radially outward therefrom;
attaching a crossover manifold to the fuel peg and in fluid communication with the radially inner secondary fuel passage and the fuel peg; and
butt welding the crossover manifold to the corresponding tubes that define the tertiary passage and the radially inner secondary passage.

14. The method of claim 13, wherein the step of butt welding the crossover manifold to the corresponding tubes that define the tertiary passage and the radially inner secondary passage further comprises tungsten inert gas welding.

15. The method of claim 13, wherein the step of butt welding the crossover manifold to the corresponding tubes that define the tertiary passage and the radially inner secondary passage further comprises electron beam welding.

16. The method of claim 13, wherein the step of butt welding the crossover manifold to the corresponding tubes that define the tertiary passage and the radially inner secondary passage further comprises brazing.

17. The method of claim 13, wherein the step of butt welding the crossover manifold to the corresponding tubes that define the tertiary passage and the radially inner secondary passage further comprises butt welding surfaces of the crossover manifold to surfaces of the corresponding tubes that define the tertiary passage and the inner secondary passage.
